(19) United States
(12) Patent Application Publication
(10) Pub. No.: US 2009/0251411 A1
(43) Pub. Date: Oct. 8, 2009

(54) Computer input device for automatically scrolling in different speed

(76) Inventor: Chun-Che Chen, San Chong (TW)

Correspondence Address: Raymond Sun, 12420 Woodhall Way, Tustin, CA, 92782, US

(21) Appl. No.: 12/154,255

(22) Filed: May 21, 2008

(30) Foreign Application Priority Data
Apr. 2, 2008 (TW) TW097112070

(51) Int. Cl. G09G 5/08

(52) U.S. Cl. 345/158

(57) ABSTRACT

A computer input device includes a body and a trace-detecting module coupled to the body. The body has a micro control unit (MCU), and the trace-detecting module has a light pervious area, and a trace-detecting unit. The trace-detecting unit further includes a light source and a sensor. The sensor senses a reflected light beam for a user's digit movement on the light pervious area at a velocity which can be sensed by the sensor. If an automatically scrolling mode is activated and the velocity exceeds a threshold stored in the MCU, then the MCU executes automatic scrolling at a predetermined scrolling speed.

### BACKGROUND OF THE INVENTION

1. Field of the Invention

The present invention relates to a computer input device and a method thereof for scrolling; and in particular, to an input device which detects the variation of a reflected light beam and executes an automatic scrolling function.

2. Description of the Prior Art

The so-called “scrolling” in an application is usually accomplished by a roller-like device on the top of a computer mouse that is used to scroll the content in the application. Once the roller is rotated, the non-displayed portion of an application can be displayed line-by-line or page-by-page. A rapid turning of the roller generates pulses which are stored in a buffer and interpreted as energy so that scrolling continues until stopped, or until the buffer is depleted. However, due to the abundant contents in a website or numerous data within a so-called EXCEL® program, the conventional way to scroll the contents line-by-line, page-by-page, or by dragging the scrolling bar from the top to the bottom, will cause great discomfort to the user' finger.

One possible way to solve this problem is to increase the turning number of the roller. A so-called “fast scroll wheel” is powered by a specially designed mechanism: when a user activates (rotates) the wheel, the mechanism will force the wheel to rotate and the rotation will last for a predetermined time (e.g., the wheel will be rotated for 7 seconds). However, it is difficult to assemble the components of such a “fast scroll wheel” together in the narrow space afforded by the housing of a computer mouse.

### SUMMARY OF THE DISCLOSURE

It is an object of the present invention to provide an easy way to scroll an application without raising the production cost of a computer mouse.

It is another object of the present invention to provide a fast scrolling function in different speed with a trace-detecting module.

To accomplish the objectives mentioned above, the computer input device according to the present invention includes a body and a trace-detecting module coupled to the body. The body has a micro control unit (MCU), and the trace-detecting module has a light pervious area, and a trace-detecting unit. The trace-detecting unit further includes a light source and a sensor. The sensor senses a reflected light beam for a user's digit movement on the light pervious area at a velocity which can be sensed by the sensor. If an automatic scrolling mode is activated and the velocity exceeds a threshold stored in the MCU, then the MCU executes automatic scrolling at a predetermined scrolling speed.

### BRIEF DESCRIPTION OF THE DRAWINGS

FIG. 1 is a flow chart illustrating one method according to the present invention.

FIG. 2 is a block diagram of an input device according to the present invention shown coupled to a computer.

FIG. 3 is perspective view of the input device of FIG. 2.

FIG. 4 is a sectional view of the input device of FIG. 2.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

The input device according to the present invention can be a computer mouse, trackball, game controller or the like. Also, the input device can be applied to a notebook computer, a cell phone, a personal digital assistant (PDA) or a similar device.

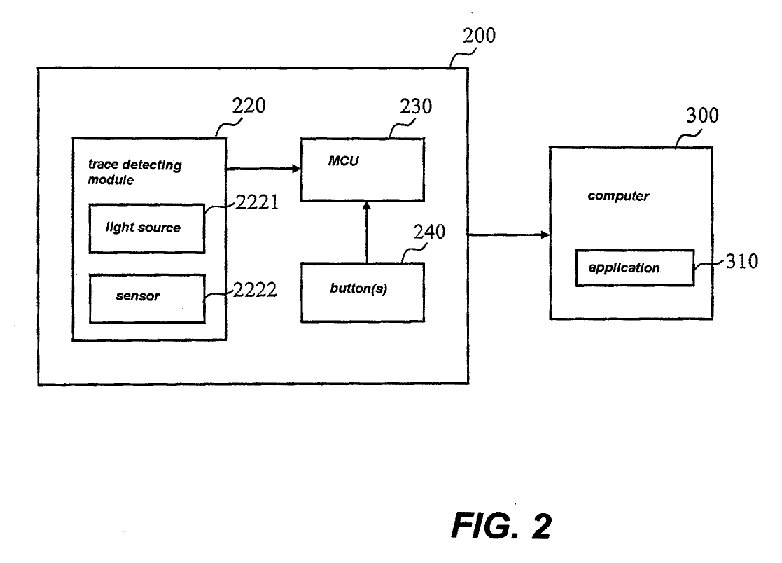

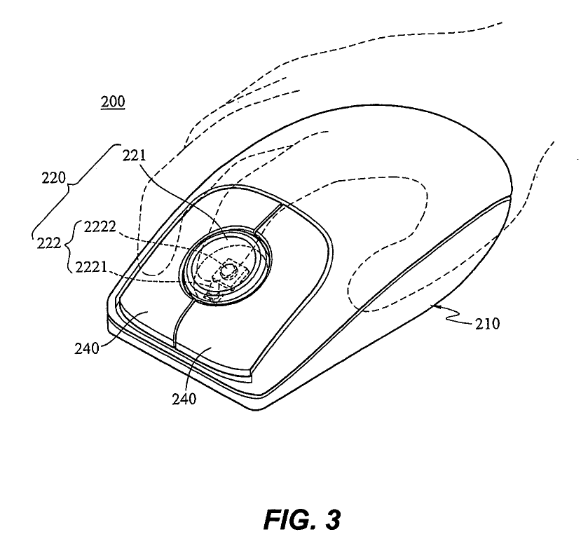

Referring to FIGS. 2-4, a computer input device 200 is provided to scroll an application 310 on the display of a computer 300. The input device 200 includes a body 210 and a trace-detecting module 220 that is provided on the body 210. The body 210 has a plurality of keys 240, and a micro control unit (MCU) 230 within the body 210. The MCU 230 is coupled to the trace-detecting module 220 at one end and to the keys 240 at another end. The MCU 230 may also be coupled to any conventional coordinate detecting module for detecting the movement of the mouse so as to control the movement of a cursor on the computer display. The trace-detecting module 220 according to the present invention has at least a light pervious area 221, and a trace-detecting unit 222. The trace-detecting unit 222 further includes at least a light source 2221 and a sensor 2222. The sensor 2222 can be a conventional image sensor, such as those used for a conventional optical mouse. In another embodiment, the sensor 2222 can be a radiation sensor such as that disclosed in U.S. Pat. No. 6,872,931. The sensor 2222 detects the variation of the reflected light beam from the light pervious area 221 for the digit's movement.

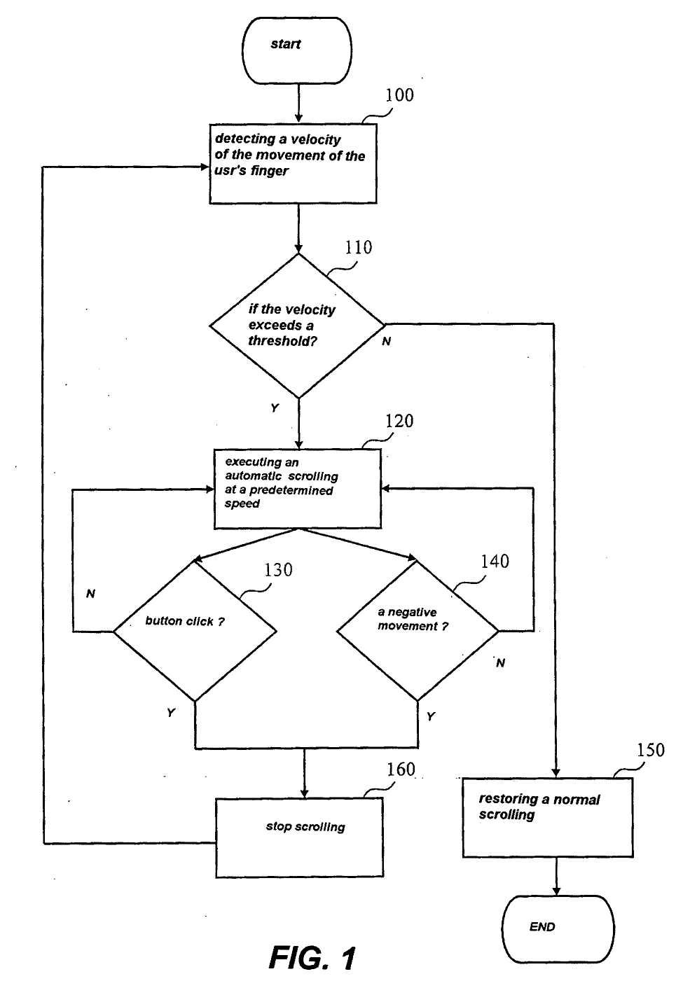

FIG. 1 is a flowchart that illustrates the steps of a method according to the present invention utilizing the input device 200. To begin with, the light source 2221 projects a light beam to the light pervious area 221 to cause the light beam to be reflected from the light pervious area 221, and the sensor 2222 detects the reflected light beam. The MCU 230 measures the variation of the reflected light beam from the movement of the user's digit using techniques known in the art, such as the technique described in U.S. Pat. No. 6,552,713. Movement of a user's digit or finger on the light pervious area 221 will generate a scrolling signal that is dependent upon the direction of the finger movement. Once a specific key (not shown) or a combination of keys (240) has been activated during an automatic scrolling mode (step “start” in FIG. 1), the velocity of the finger movement can be calculated from the reflected light beams detected by the sensor 2222 (step 100). The MCU 230 can be preset with several or many thresholds (which can be preset by the manufacturer), such that the velocity of the finger movement can be compared with the thresholds. The thresholds can be set in many different ways. For example, a threshold can be set at 2 cm/second for the finger movement. If the finger movement traverses more than 2 cm a second, then the finger must be moving faster than the anticipated normal speed and automatic scrolling can be initiated. As another example, the user's finger movement can be detected to see if it exceeds a threshold of x times per second. x can be the threshold, and for example, be set at 100. So if the finger's movement is detected more than 100 times in a second, it means that the finger is moving faster than the anticipated normal speed and automatic scrolling can be initiated.

Next, in step 110, it is determined if the velocity exceeds one of the thresholds. If no, then processing proceeds to step 150, where a normal scrolling function (e.g., line by line, or page by page) is restored or maintained. On the other hand, if the velocity exceeds a designated or selected threshold, the MCU 230 executes automatic scrolling at a predetermined scrolling speed in step 120. In other words, the MCU 230 can vary the scrolling speed according to the different velocities of the user's finger moving on the light pervious area 221. In this regard, it is understood that the scrolling speed can be pre-set or changed by the user through the driver program (software) of the input device 200 according to principles that are well known in the art.

Next, in step 140, it is determined whether the user's finger moves in a direction opposite to the previous movement. If so, the MCU 230 will immediately stop the automatic scrolling in step 160. Alternatively, if the user clicks one of keys 240 while scrolling (see step 130), then the MCU 230 will also immediately stop the automatic scrolling mode in step 160. From step 160, processing returns to step 100 to detect the velocity of the movement of the user's finger.

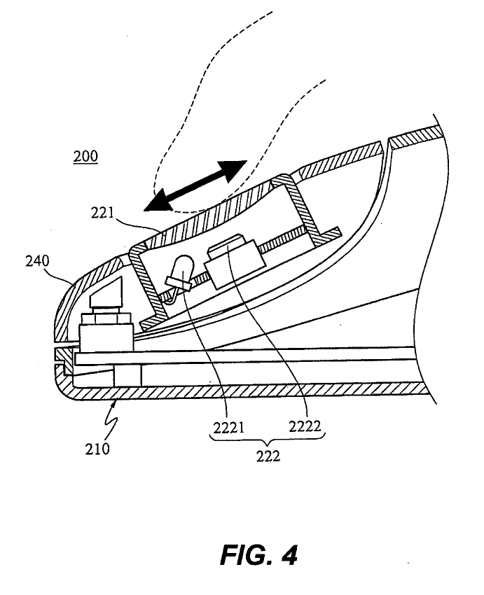

It is appreciated that the light pervious area 221 can be a convex or concave lens, a transparent platform or the like, whose location is opposed to the sensor as shown in FIG. 4. It is also understood that, if the user moves his or her fingers on the light pervious area 221 from up to down, the application will be scrolled from up to down. On the contrary, if the user moves his or her fingers on the light pervious area 221 from left to right, the application will be scrolled from left to right.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A computer input device comprising:
a body having a plurality of keys, a micro control unit housed inside the body, and a trace-detecting module coupled to the body, the micro control unit storing threshold values;
means for activating an automatically scrolling mode;
wherein the trace-detecting module has a light pervious area, and a trace-detecting unit, the trace-detecting unit further including means for detecting the velocity of the movement of a user's digit on the light pervious area; and
means for comparing the detected velocity with the stored threshold values, and for executing automatic scrolling if the detected velocity exceeds one of the threshold values.

2. The input device of claim 1, wherein the detecting means includes a light source and a sensor, with the light source projecting a light beam to the light pervious area, and the sensor detecting a light beam reflected from the light pervious area.

3. The input device of claim 1, wherein the light pervious area is a lens positioned opposite to the sensor.

4. The input device of claim 3, wherein the lens is a convex lens.

5. The input device of claim 1, wherein the sensor is a sensor that senses variation of the reflected light beam from the digit's movement.

6. The input device of claim 1, further including means for stopping the automatic scrolling.

7. A method for scrolling an application on a computer display through the use of a computer input device, the method comprising the steps of:
activating an automatic scrolling mode;
detecting a velocity of the movement of a user's digit across a light pervious area; and
executing automatic scrolling if the detected velocity exceeds a predetermined threshold.

8. The method of claim 7, wherein the activating step is accomplished by activating one or more keys of the input device.

9. The method of claim 7, wherein the detecting step includes:
providing a trace-detecting module which includes the light pervious area, a light source and a sensor; and
directing light from the light source to the light pervious area to cause the light beam to be reflected towards the sensor; and
measuring the variation of the reflected light beam from the movement of the user's digit.

10. The method of claim 7, further including moving the user's digit in a direction opposite to the previous direction to stop the automatic scrolling.

11. The method of claim 7, further including activating a key to stop the automatic scrolling.
